(19) United States
(12) Patent Application Publication
(10) Pub. No.: US 2007/0031810 A1
(43) Pub. Date: Feb. 8, 2007

(54) Squeegee eraser with built-in designs

(76) Inventors: Ben Hoch, Irvine, CA (US); Michael Cerillo, San Clemente, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/495,491

(22) Filed: Jul. 28, 2006

Related U.S. Application Data
(60) Provisional application No. 60/703,930, filed on Jul. 29, 2005.

(51) Int. Cl. B43L 1/00

(52) U.S. Cl. 434/408

(57) ABSTRACT

A multipurpose device 10 is provided that comprises an assembly permitting a user to manually apply the assembly to one or more tasks. The assembly comprises a handle 12 and a head 14. The handle 12 may be detachable and may serve to permit the user to hold the assembly and may be configured to serve a use in addition to holding the assembly. The head 14 may be detachable and may permit a user to erase from a board any text or graphics applied to the board in a removable fashion. The device 10 is configured so as to be usable with a dry erase board if so desired.

### CROSS-REFERENCE TO RELATED APPLICATIONS

This application claims priority to U.S. Provisional Patent Application Ser. No. 60/703,930, filed on Jul. 29, 2005, and the specification thereof is incorporated herein by reference.

### BACKGROUND OF THE INVENTION

1. Field of the Invention

The present invention relates generally to multi-purpose writing implements, and more specifically, to a uniquely configured multi-purpose squeegee eraser with built-in multi-function components and designs.

2. Description of the Related Art

A dry erase board is a convenient tool that allows a user to write on the board using a marker and erase the board using a dry eraser. The dry erase board is preferable to standard chalk boards because no chalk dust is produced using the dry erase board and marker, the marker and dry erase board combination are generally easier to write with, and the marker and board combination can be used in a variety of colors and tends to produce images of greater contrast, thus being generally easier to visually perceive.

Dry erase boards are now used in a variety of applications, and may be configured to be mounted on walls, used in combination with easels, or be suited to handheld display equipment. Additionally, the markers used in conjunction with dry erase boards are also available in a variety of sizes, colors, and writing tip configurations. Finally, dry erase erasers are available in a variety of configurations as well. Thus, dry erase products are now commercially available to be used in a broad variety of applications.

In typical uses, dry erase products assist the user to make visual presentations to other persons, such as in a meeting or discussion. Frequently, dry erase boards include equipment that allows the marker and eraser to be stored in close proximity to the board so that the marker and eraser do not get misplaced. Generally, this includes the incorporation of a ledge or other receptacle positioned adjacent to the board, and often connected to a lower edge of the board. Such a configuration is extremely common and is almost always used in connection with standard chalk boards and the chalk and eraser used thereon.

In addition to the use of a ledge, other receptacles, such as a clip mounted to an edge of the dry erase board, have also been implemented. In such cases, the clip is mounted to an edge of the dry erase board and is operative to hold a marker so that the marker can be easily stored and secured with the board. Such products and features evidence the need for the user to be able to conveniently store the dry erase board together with the equipment necessary to make use of the board.

The improved features of the dry erase board, including its compatibility to store dry erase products, such as markers and erasers, there is a continuing need to simplify and integrate dry erase products in order to provide maximum convenience to the user.

To that end, there is a need in the art for an integrated dry erase device that combines the functionality and features of various dry erase products. Further, there is a need in the art for a device that promotes the ready storage and access of dry erase products so that the user may be benefited thereby. Finally, there is a need in the art for a device that integrates the features and functionality of markers and erasers into a compact, versatile, and stowable tool.

### SUMMARY OF THE INVENTION

In accordance with an embodiment, a multipurpose device is provided that comprises an assembly permitting a user to manually apply the assembly to one or more tasks. The assembly comprises a detachable handle and a detachable head. The detachable handle may serve to permit the user to hold the assembly and that is configured to serve a use in addition to holding the assembly. The detachable head can permit a user to erase from a board any text or graphics applied to the board in a removable fashion. The device is configured so as to be usable with a dry erase board if so desired.

The handle can define anterior and posterior ends, and the head can defines a handle receiving portion and an eraser portion. The anterior end can be sized and configured to be removably attachable to the handle receiving portion of the head. Additionally, the handle receiving portion of the head can include an internal cavity disposed within the head. The internal cavity can be sized and configured to removably receive the anterior end of the handle. However, the handle can also be configured to be a writing implement that is removably attachable to the head and is operative to allow a user to hold the assembly.

In another embodiment, the posterior end of the handle can include an attachment element being configured to facilitate the removable attachment of the device to a background structure. The attachment element can be a magnet disposed along the posterior end of the handle.

Further, the handle can include an aperture disposed at the anterior end and an implement fastener disposed at the anterior end. The implement fastener can be configured to support one of a writing implement and a writing tip adjacent the aperture. The writing tip can be removably attachable to the implement fastener. In addition, the handle can also include an internal reservoir. In such an embodiment, the internal reservoir can be in fluid communication with the aperture of the handle to facilitate the deliver of a writing fluid to the writing tip.

In yet another embodiment, the handle can further include a holder being configured to removably receive a writing implement. The holder can be configured as a longitudinal channel disposed along the handle. The holder can include at least one retaining element formed along the channel and be configured to secure the writing implement within the channel when the writing implement is disposed within the channel.

Finally, in accordance with another embodiment, the assembly can further include an eraser pad disposed along the eraser portion of the head.

### BRIEF DESCRIPTION OF THE DRAWINGS

FIG. 1 is a perspective view of a multi-purpose device incorporating a detachable handle and a detachable head made in accordance with an embodiment of the present invention.

FIG. 2 is a perspective exploded view of the device illustrated in FIG. 1.

FIG. 3 is a side view of the device illustrated in FIG. 1.

FIG. 4 is a top plan view of the handle including a securing member, in accordance with an embodiment.

FIG. 5 is a top plan view of the head formed in accordance with another embodiment.

FIG. 6 illustrates an embodiment of the handle including a spray pump.

FIG. 7 illustrates the embodiment of the handle shown in FIG. 6 with the spray pump shown as being removably fastenable to the handle.

FIG. 8 is an illustration of another embodiment of the handle including a writing portion.

FIG. 9 is yet another embodiment of the handle wherein the spray pump and the writing portion are integrally combined into the handle.

FIG. 10 illustrates an embodiment of the handle wherein the handle includes a holder for removably receiving a writing implement.

FIG. 11 illustrates another exemplary embodiment of the handle, wherein the handle combines the holder and the spray pump.

### DETAILED DESCRIPTION OF THE PREFERRED EMBODIMENT

While the present description sets forth specific details of various embodiments, it will be appreciated that the description is illustrative only and should not be construed in any way as limiting. Furthermore, various applications of such embodiments and modifications thereto, which may occur to those who are skilled in the art, are also encompassed by the general concepts described herein.

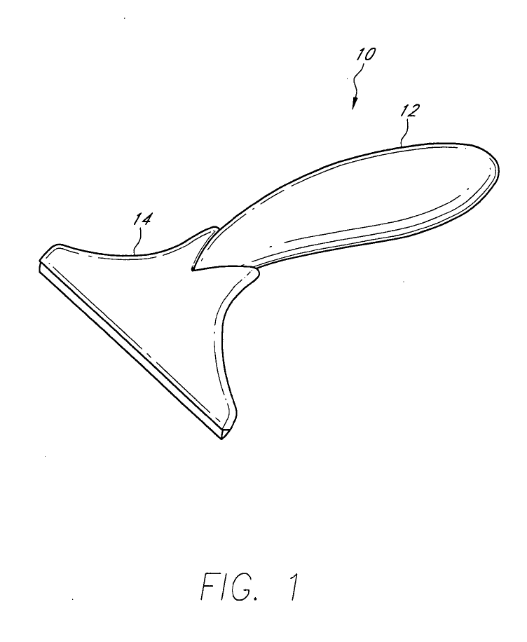

Referring now to the drawings wherein the showings are made for purposes of illustrating preferred embodiments of the present invention, and not for purposes of limiting the same, FIG. 1 is a perspective view of a multi-purpose device 10 that comprises an assembly that can be manually applied by a user to one or more tasks. While various embodiments disclosed herein will be described with reference to writing and erasing implements, and more specifically, dry erase products, these embodiments should not be limited to such uses alone, but may be incorporated into a variety of other products and applications.

Referring specifically to FIG. 1, the device 10 can include a handle 12 and a head 14. The handle 12 can be configured to be detachable and serve to permit the user to hold the assembly. Further, the handle 12 can be configured to serve a use in addition to holding the assembly. Exemplary uses for the handle 12 are described herein, and may further include other such uses that are within the scope of embodiments of the embodiments discussed herein. The head 14 can be configured to be detachable and to permit a user to erase from the board any text or graphics applied to the board in a removable fashion. Thus, the device 10 can be configured to provide the user with a compact, unitary multi-purpose tool that can allow the user to erase text or graphics, write text or graphics, clean surfaces, or perform various other functions as described in exemplary fashion herein. Although various embodiments described herein can include a detachable handle 12 and a detachable head 14, it is also contemplated that the handle 12 and the head 14 can be integrally formed as a single continuous structure that incorporates one or many materials. Further, the device 10 can be formed using a variety of processes known in the art, such as injection molding.

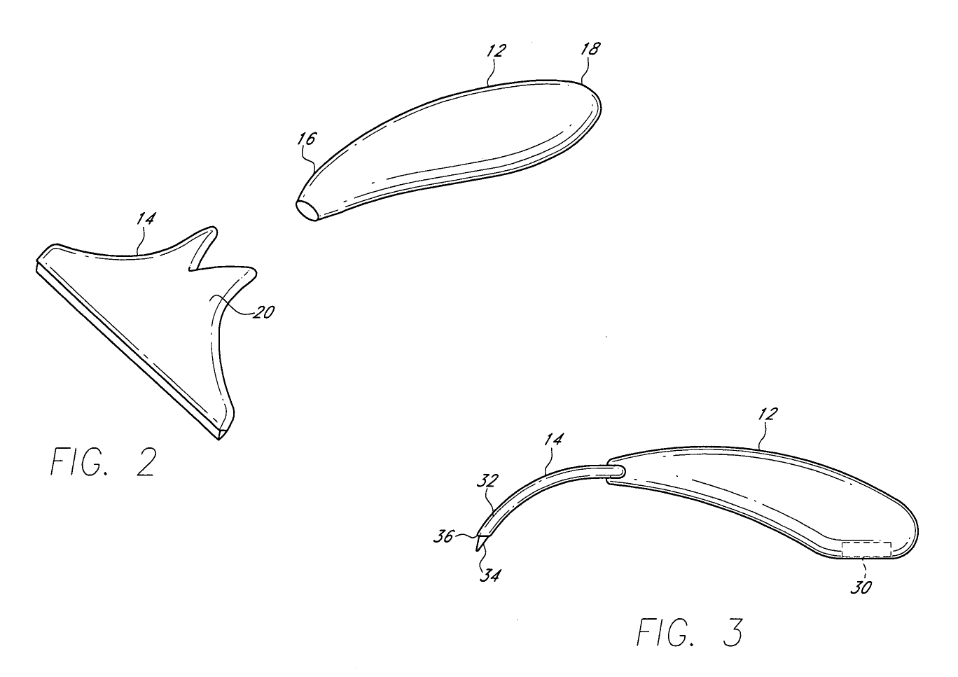

As shown in FIG. 2, the handle 12 is preferably removably attachable to the head 14. The handle 12 defines an anterior end 16 and a posterior end 18. The handle 12 can be variously configured in a variety of shapes and sizes, and can include such features as ergonomic grips and the like. As illustrated in FIGS. 1-2, the handle 12 can preferably be configured to include a bulbous posterior end 18 and taper towards the anterior ends 16 of the handle 12. In addition, as illustrated in FIG. 3, the handle 12 may be generally arcuately shaped in order to facilitate the handling thereof by the user.

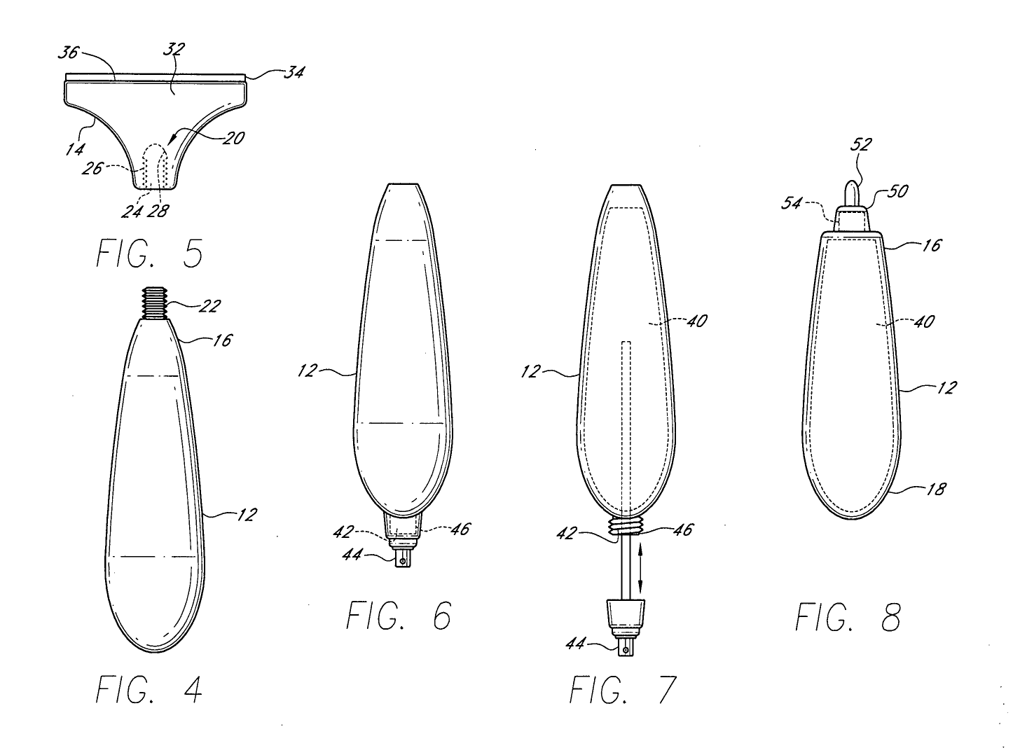

Referring now to FIG. 4, the anterior end 16 of the handle 12 can be configured to be removably attachable to the head 14. As shown in FIG. 5, the head 14 can include a handle receiving portion 20 wherein the anterior end 16 of the handle 12 can be received. In this regard, as illustrated in FIG. 4, the anterior end 16 of the handle 12 can be formed to include a securing member 22 that substantially mates with the handle receiving portion 20 of the head 14. The handle receiving portion 20 and the securing member 22 can each be formed in a variety of configurations, and the teachings herein will enable one of skill in the art to develop multiple configurations that will provide for the removable attachment of the handle 12 to the head 14.

In accordance with an embodiment illustrated in FIGS. 4 and 5, the handle receiving portion 20 of the head 14 can be formed to include an internal cavity 24 that is sized and configured to receive the securing member 22 of the handle 12. In this regard, the handle receiving portion 20 can be formed to include at least one retaining element 26. As illustrated in FIG. 5, the retaining element 26 may be disposed within the handle receiving portion 20, and more specifically, along an internal surface 28 of the cavity 24. In some embodiments, the retaining element 26 can be formed as a single circular protrusion extending inwardly from the interior surface 28 of the cavity 24. Alternatively, the retaining element 26 can be formed as a helical ridge on the interior surface 28 of the cavity 24 so as to correspond to a threaded securing member 22. Furthermore, other various modifications may be made to the handle receiving portion 28 of the head 14 in order to facilitate the connection between the head 14 and the handle 16.

In accordance with another embodiment, the securing member 22 of the handle 12 can be formed to include an exterior thread pattern, exterior ridges or nubs, or various other geometric shapes corresponding to the handle receiving portion 20 of the head 14. In this regard, it is contemplated that the securing member 22 and the handle receiving portion 20 can be configured to create a removable attachment in a variety of ways, such as by a friction fit, a pressure fit, a snap or locking fit, and by means of releasable adhesives, such as Velcro and the like. Furthermore, other attachment elements, such as pins, magnets, screws, and the like, may be used in addition to the securing member 22 and the handle receiving portion 20 in order to facilitate the removable attachment of the handle 12 to the head 14.

Referring again to FIG. 3, the handle 12 may also be formed to include an attachment element 30. The attachment element 30 can be configured as a variety of shapes and can include various adhesive elements, such as magnets, suction cups, Velcro, and the like. In this regard, the attachment element 30 can be formed as a hook to rest on a corresponding structure of the board. As depicted in FIG. 3, the attachment element 30 may be a magnet disposed along the posterior end 18 of the handle 12. The magnet can be internally disposed within the handle 12 or alternatively, can be at least partially exposed at the posterior end 18 of the handle 12. It is contemplated that the attachment element 30 of the handle 12 can therefore be configured to facilitate the removable attachment of the device 10 to a background structure, such as a wall or to the board itself. In this regard, the background structure can include any variety of structures, such as the wall or the board, and any other structure whereto the device 10 may be attached or wherein the device 10 may be stored.

As illustrated in FIGS. 3 and 5, the head 14 can be formed to include an eraser portion 32. In this regard, the device 10 can further include an eraser pad 34 that is attachable to along a contact surface 36 of the eraser portion 32. The eraser pad 34 can be replaceable, can be made of a felt-type material, and can be made to be removably attachable to the eraser portion 32. The embodiment of the eraser portion 32 illustrated in FIGS. 2, 3, and 5 is shown as having a squeegee-like-shaped contact surface 36. However, the eraser portion 32 and the contact surface 36 thereof can also be formed as a pin-point or blunted tip or it can define a generally flat rectangular or circular contact surface 36 onto which the eraser pad 34 is attached; in short, the eraser portion 32 and contact surface 36 can be configured in any variety of two or three dimensional surfaces onto which the eraser pad 34 can be attached.

Referring now to FIGS. 6-11, additional embodiments of the handle 10 are shown. It is contemplated that these embodiments may be used singly or in combination with each other in order to provide a product that meets the needs and demands of the user. These various embodiments, as discussed above and herein, can be variously modified by one of skill in the art and are provided for exemplary purposes only. Thus, the handle 12 may be variously configured to provide the user with not only a means for holding and handling the assembly, but can also be configured to serve various additional uses related to the application for which the device 10 is intended.

In the embodiments illustrated in FIGS. 6-9 and 11, the handle 12 can be configured to include at least one reservoir 40 and at least one aperture 42 that is in fluid communication with the internal reservoir 40. The handle 12 can therefore be at least partially hollow. Referring specifically to FIGS. 6 and 7, the device 10 may further comprise a spray pump 44 that is removably connectable to a mouth 46 of the aperture 42. The spray pump 44, as is known in the art, can be attached to the mouth 46 of the aperture 42 via threadable engagement or otherwise, in order to ensure that a fluid disposed within the reservoir 40 of the handle 12 does not leak from within the cavity 40. In the embodiments shown in FIGS. 6 and 7, the spray pump 44 can be used to distribute a cleaning solution onto the board in order to facilitate the clean-up of any text or graphics applied to the board. Thus, the device 10 can integrate various components into a single tool. In a preferred embodiment, the device 10 can include various dry erase tools, such as dry erase cleaning solution used in conjunction with the spray pump 44 and the internal reservoir 40, as well as eraser functionality of the head 14. Furthermore, as discussed below, the handle 12 can also be configured to include writing functionality and storage functionality.

Referring now to FIG. 8, another embodiment of the device 10 is illustrated wherein the device 10 is configured to use an integrated writing component 50. The writing component 50 can include a writing tip 52 and can be disposed with the writing tip 52 thereof being disposed at the anterior end 16 of the handle 12. The writing component 50 can be internally or externally disposed relative to the handle 12. For example, in one embodiment, the writing component 50 can be a writing implement such as a marker or otherwise, which is separable and separately utilizable independently of the handle 12 and device 10. Thus, in such an embodiment, the writing component 50 can be removably introducible into the handle 12.

In accordance with one implementation, the reservoir 40 can be sized and configured to receive the writing implement 50. The reservoir 40 can include at least one implement fastener 54 disposed toward the anterior end 16 and/or the posterior end 18 of the handle 12. As shown in FIG. 8, the implement fastener 54 can extend internally about the writing implement 50 in a longitudinal or circumferential direction in order to securely retain the writing implement 50. In such an embodiment, the writing component 50 can comprise the writing tip 52 and be in fluid communication with the reservoir 40 for facilitating the delivery of a writing fluid to the writing tip 52. Additionally, the handle 12 in such an embodiment can be intended for non-refillable single-use applications, or alternatively, the handle 12 can be configured to allow the user to remove the writing tip 52 therefrom in order to refill the reservoir 40 with writing fluid.

In another embodiment, the implement fastener 54 can extend externally about the writing implement 50 in a longitudinal or circumferential direction in order to securely retain the writing implement 50, such as when the writing implement 50 is a marker. In such an embodiment, the writing component 50 can be passable through the implement fastener 54 and be retained thereat, for example, by a series of protrusions or barbs that circumferentially engage an exterior of the writing component 50, a pressure/frictional engagement between the implement fastener 54 relative to the writing component 50, or so forth. Further, the writing component 50 and/or writing tip 52 can be color-coded corresponding to the color of the writing fluid within the reservoir 40 and to indicate the same to the user.

As mentioned above, the implement fastener 54 can be positioned at the anterior end 16 and/or the posterior end 18 of the handle. In one embodiment, the device 10 can be integrally formed and the handle 12 can be configured with the writing implement 50 being receivable by the implement fastener 54 at the posterior end 18 of the handle 12. In another embodiment, the implement fastener 54 is positioned at the anterior end 16 of the handle, with the writing implement 50 fastenable thereto, as described further below. However, in accordance with yet another embodiment, the handle 12 can be configured to accommodate two writing implements 50, for example, with one disposed at each of the respective anterior and posterior ends 16, 18 of the handle. Such embodiments can be fabricated in accordance with the teachings herein and modified by one of skill in light of such teachings.

In the embodiments represented by FIG. 8, it is contemplated that either the anterior end 16 of the handle 12 or the writing component 50 itself can be configured to be removably attachable to the head 14. For example, in one embodiment, the securing member 22 can extend longitudinally and/or circumferentially about the writing component 50 such that the securing member 22 is engageable with the head 14. However, the head 14 can also be configured to receive at least a portion of the writing component 50, by which the head 14 would be indirectly removably attachable to the handle 12 due to the intermediate use and secure attachment of the writing component 50. In such an embodiment, the writing component 50 should be securely attached to the handle 12 to ensure that the device 10 is properly and securely assembled. In accordance with another embodiment, the handle 12 can be a marker, such as a standard-sized marker that is generally available in commercial outlets presently and prospectively. This embodiment could therefore permit the user to replace the handle 12 of the device 10 as desired. Implementations of such embodiments preferably provide that the head 14 protects the writing component 50 to preserve it from drying out or being otherwise damaged or rendered inoperative. In this regard, the head 14 can be formed to include a cap into which at least a portion of the writing component 50 is received.

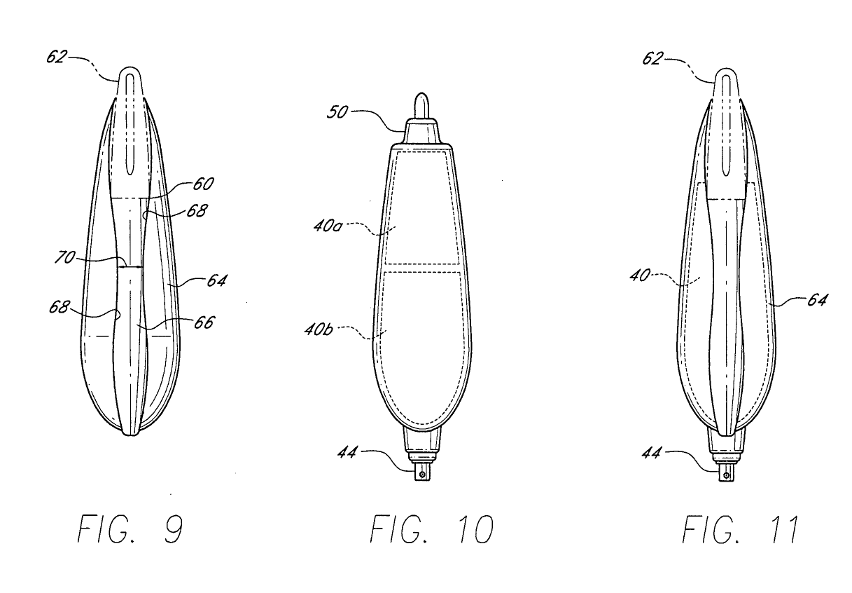

Referring now to the embodiment illustrated in FIG. 9, the handle 12 can be formed to include a holder 60. As illustrated, the holder 60 can be sized and configured to substantially correspond to the shape of a writing implement 62 (shown in dashed lines to clarify that such implement 62 forms only a potential environmental feature of the device 10). The holder 60 can be disposed on an exterior surface 64 of the handle 12. The exterior surface 64 can be formed to define various contours and geometric shapes that facilitate retention of the implement 62 by the holder 60. In some embodiments, the holder 60 can be formed as a substantially elongate longitudinal channel 66 and include at least one holding element 68 formed along the channel 66 and being configured to secure the writing implement 62 within the channel 66 when the writing implement 62 is disposed within the channel 66. In this regard, the holding element 68 can be configured as at least one or more lips, preferably dual opposing lips, that extends upwardly and over the channel 66 in order to define a reduced opening 70 that is less than the radial size of the writing implement 62. In such an embodiment, the handle 12 is preferably made of a resilient material such that the writing implement 62 can be passable through the reduced opening 70 with the holding element 68 being temporarily resiliently displaced for allowing passage of the implement 62 into the channel 66. Other various structures and embodiments can be implemented such that the holder 60 securely and releasably receives the writing implement 62.

In accordance with yet other embodiments, FIGS. 10 and 11 illustrate that the handle 12 can be configured to incorporate various features discussed above. In FIG. 10, the handle 12 is illustrated as incorporating two reservoirs 40a, 40b that are respectively in fluid communication with the spray pump 44 and the writing component 50. The shape and proportion of the reservoirs 40a, 40b can be modified as desired. Further, as illustrated in the embodiment of FIG. 11, the handle 12 can also be formed to include the holder 60 and the reservoir 40 and spray pump 44. There are other various combinations and implementations of the teachings herein are contemplated as being within the scope of the embodiments discussed.

The individual components of the device 10 can be fabricated of various materials. The handle 12 can preferably be made of a plastic, metal, rubber, composite, or other material that facilitates proper gripping of the device 10 by the user. Further, the functionality performed by the handle 12 can also be considered in material choice. As discussed above, the handle 12 can be made of a resilient material in order to be elastically deformable, in cases such as when the holder 60 is incorporated into the handle 12. Additionally, the handle 12 can be fabricated of a plurality of material types. For example, the handle 12 can be made of a hollow bulbous core (utilizable as the internal reservoir 40) that is surrounded by an external layer of another material. In such an embodiment, the external surface 64 of the handle 12 can be of a tacky material and can include various patterns or designs (including ergonomic designs as discussed above).

Additionally, the head 14 of the device 10 can also be fabricated of various materials in accordance with desired functionalities. The head 14 can also be made of a plastic, metal, rubber, composite, or other material. The material can be flexible, but should preferably provide sufficient rigidity in order to support the eraser portion 32 firmly against the board when the user presses the device 10 thereagainst. The head 14 can be made of a opaque or translucent materials, as desired. Further, additional features can be incorporated into the head 14 that can be fabricated of other materials. For example, the eraser pad 34 can be made of a felt or cloth-type material that can be smooth and porous in order to efficiently erase the marker markings from the board. In another embodiment, the handle receiving portion 20 can be formed to include other features, such as tacky plastic or rubber rings disposed internally therein that facilitate the engagement of the handle 12 to the head 14. Numerous other features and designs can also be produced that are benefited by the use of various materials, either in combination or individually.

Although this invention has been described in terms of certain preferred embodiments, other embodiments that are apparent to those of ordinary skill in the art are also within the scope of this invention. Accordingly, the scope of this invention is intended to be limited only by the appended claims.

What is claimed is:

1. A multipurpose device comprising
an assembly permitting a user to manually apply the assembly to one or more tasks, the assembly comprising:
a detachable handle that may serve to permit the user to hold the assembly and that is configured to serve a use in addition to holding the assembly; and
a detachable head for permitting a user to erase from a board any text or graphics applied to the board in a removable fashion;
whereby the device is configured so as to be usable with a dry erase board if so desired.

2. The device of claim 1 wherein the handle defines an anterior end and the head defines a handle receiving portion, the anterior end being sized and configured to be removably attachable to the handle receiving portion of the head.

3. The device of claim 2 wherein the handle receiving portion includes an internal cavity disposed within the head, the internal cavity being sized and configured to removably receive the anterior end of the handle.

4. The device of claim 1 wherein the handle defines a posterior end, the posterior end including an attachment element being configured to facilitate the removable attachment of the device to a background structure.

5. The device of claim 4 wherein the attachment element is a magnet disposed along the posterior end of the handle.

6. The device of claim 1 wherein the handle defines an anterior end, an aperture disposed at the anterior end and an implement fastener disposed at the anterior end, the implement fastener being configured to support one of a writing implement and a writing tip adjacent the aperture.

7. The device of claim 6 wherein the writing tip is removably attachable to the implement fastener.

8. The device of claim 6 wherein the handle further includes an internal reservoir.

9. The device of claim 8 wherein the internal reservoir is in fluid communication with the aperture of the handle to facilitate the deliver of a writing fluid to the writing tip.

10. The device of claim 1 wherein the handle further includes a holder being configured to removably receive a writing implement.

11. The device of claim 10 wherein the holder is configured as a longitudinal channel disposed along the handle, the holder including at least one retaining element formed along the channel and being configured to secure the writing implement within the channel when the writing implement is disposed within the channel.

12. The device of claim 1 wherein the head defines at least one eraser portion and the assembly further includes an eraser pad disposed along the eraser portion.

13. The device of claim 1 wherein the handle is a writing implement, the writing implement being removably attachable to the head and being operative to allow a user to hold the assembly.

14. A detachable head for permitting a user to erase from a board any text or graphics applied to the board in a removable fashion, the head being detachably connectable to a handle to form an assembly that permits the user to manually apply the assembly to one or more tasks, the head being configured so as to be usable with a dry erase board if so desired.

15. The device of claim 1 wherein the head defines at least one eraser portion and the assembly further includes an eraser pad disposed along the eraser portion.
